(19) United States
(12) Patent Application Publication
(10) Pub. No.: US 2014/0016831 A1
(43) Pub. Date: Jan. 16, 2014

(54) APPARATUS FOR RETRIEVING INFORMATION ABOUT A PERSON AND AN APPARATUS FOR COLLECTING ATTRIBUTES

(71) Applicant: KABUSHIKI KAISHA TOSHIBA, Tokyo (JP)

(72) Inventors: Kentaro Yokoi, Tokyo (JP); Tatsuo Kozakaya, Kanagawa-ken (JP)

(73) Assignee: Kabushiki Kaisha Toshiba, Tokyo (JP)

(21) Appl. No.: 13/856,113

(22) Filed: Apr. 3, 2013

(30) Foreign Application Priority Data
Jul. 11, 2012 (JP) 2012-155991

(51) Int. Cl. G06K 9/00

(52) U.S. Cl. CPC G06K 9/00288
USPC 382/115

(57) ABSTRACT

A first acquisition unit is configured to acquire the image including a plurality of frames. A first extraction unit is configured to extract a plurality of persons from the frames, and to extract a plurality of first attributes from each of the persons. The first attributes feature each person. A second extraction unit is configured to extract a plurality of second attributes from a first person indicated by a user. The second attributes feature the first person. A retrieval unit is configured to retrieve information about a person similar to the first person from the persons, based on at least one of the second attributes as a retrieval condition. An addition unit is configured to, when at least one of the first attributes of a retrieved person by the retrieval unit is different from the second attributes, add the at least one of the first attributes to the retrieval condition.

### CROSS-REFERENCE TO RELATED APPLICATION

This application is based upon and claims the benefit of priority from Japanese Patent Application No. 2012-155991, filed on Jul. 11, 2012; the entire contents of which are incorporated herein by reference.

### FIELD

Embodiments described herein relate generally to an apparatus for retrieving information about a person and an apparatus for collecting attributes.

### BACKGROUND

As a video retrieval device mainly used for video-monitoring, a system for retrieving by color information of a person image is used. Furthermore, by indicating a face or clothes thereof, a system for retrieving the person from a video is used.

As technique for identifying a person, for example, by using face-recognition, a person in question is decided as the same person (target person) or another person. However, in videos generally imaged, the person's face cannot be often seen because of a profile or clothes (such as a hat or glasses) thereof. In this case, person-retrieving is difficult for a video (including a static image). Furthermore, as to attributes except for biometric information of the person (individual), for example, clothes such as above-mentioned hat or glasses, a degree of change thereof is large. In attributes related to biometric information, for example, a hairstyle is easily changed (not so often in comparison with clothes). If such attribute of the same person is changed, person-retrieving is difficult between a pair of the same person.

Furthermore, in order to collect training data for person-retrieving, teaching work by hands is necessary and this work takes time. Furthermore, when the teaching work is semi-automatically inputted by using face-identification technique, as mentioned-above, the person's face had better be seen.

### BRIEF DESCRIPTION OF THE DRAWINGS

FIG. 1 is a block diagram of a person retrieving apparatus according to a first embodiment.

FIG. 2 is a flow chart of processing of the person retrieving apparatus according to the first embodiment.

FIGS. 3A and 3B are schematic diagrams to explain addition of attributes according to the first embodiment

FIG. 4 is an example that a plurality of persons is extracted from a video according to the first embodiment.

FIG. 5 is a block diagram of the person retrieving apparatus having a decision unit.

FIG. 6 is a block diagram of a person retrieving apparatus according to a second embodiment.

FIG. 7 is an example that a plurality of persons is extracted from a plurality of videos according to the second embodiment.

FIG. 8 is a block diagram of an attribute collection apparatus according to a third embodiment.

FIG. 9 is an example that a plurality of persons is extracted from a video according to the third embodiment.

### DETAILED DESCRIPTION

According to one embodiment, a person retrieving apparatus includes a first acquisition unit, a first extraction unit, a second extraction unit, a retrieval unit, and an addition unit. The first acquisition unit is configured to acquire the image including a plurality of frames. The first extraction unit is configured to extract a plurality of persons from the frames, and to extract a plurality of first attributes from each of the persons. The first attributes feature each person. The second extraction unit is configured to extract a plurality of second attributes from a first person indicated by a user. The second attributes feature the first person. The retrieval unit is configured to retrieve information about a person similar to the first person from the persons, based on at least one of the second attributes as a retrieval condition. The addition unit is configured to, when at least one of the first attributes of a retrieved person by the retrieval unit is different from the second attributes, add the at least one of the first attributes to the retrieval condition.

Various embodiments will be described hereinafter with reference to the accompanying drawings.

In following embodiments, person-retrieving is performed based on a person or an attribute (that is information about a person, such as clothes) indicated as a retrieval target. Furthermore, if the person of the retrieval target has a different attribute (for example, wearing different clothes), means for adding this attribute as a retrieval target is equipped. Furthermore, in case of retrieving, means for specifying a video corresponding to a time or a position which the person (indicated as the retrieval target) cannot exist is equipped. Specifically, in case of searching a video including a person similar to the indicated person, by setting a condition such as “a person simultaneously photographed with a person A is not the person A” or “a person photographed by a camera apart from another camera photographing the person A at near time is not the person A because of restriction of moving time of the person A”, the retrieving is limited.

Furthermore, in case of collecting training data for person-retrieving, means for discriminately deciding data of target person data and another person data is equipped. Specifically, as for some person A, a function to add a condition such as “a person simultaneously photographed with the person A is another person” is equipped, data satisfying this condition is decided as another person data and trained. In the same way, as for a person photographed by a camera apart from another camera photographing the person A at near time, this person data is trained as another person data of the person A. By collecting these data, training data to retrieve the specific person A can be richly collected.

Furthermore, in case of person-retrieving, retrieval by following change of attribute (such as clothes, hairstyle) can be performed. Furthermore, data as a target of retrieval processing can be limited. Accordingly, the retrieval processing can be accelerated, and error-detection can be reduced. Furthermore, in case of collecting training data, training data for person-identification can be collected without load to add a person ID thereto.

Hereinafter, by referring to drawings, various embodiments are explained in detail. Moreover, in the present embodiment, an attribute includes a biometric attribute represented as a feature peculiar to the individual and a temporal attribute represented as a feature acquitted from the person's temporal appearance. In following explanation, a face and a shape of the person are used as the biometric attribute, and the person's clothes are used as the temporal attribute. If means for detecting information peculiar to a hand or a finger of the individual is equipped, this information may be the biometric attribute. If means for detecting a hairstyle or decorations (such as a watch, a name plate) from a video is equipped, this information may be the temporal attribute.

### The First Embodiment

As to a person retrieving apparatus of the first embodiment, even if a person of retrieval target wears clothes different from the indicated attribute, this person can be retrieved by a new attribute including the different clothes.

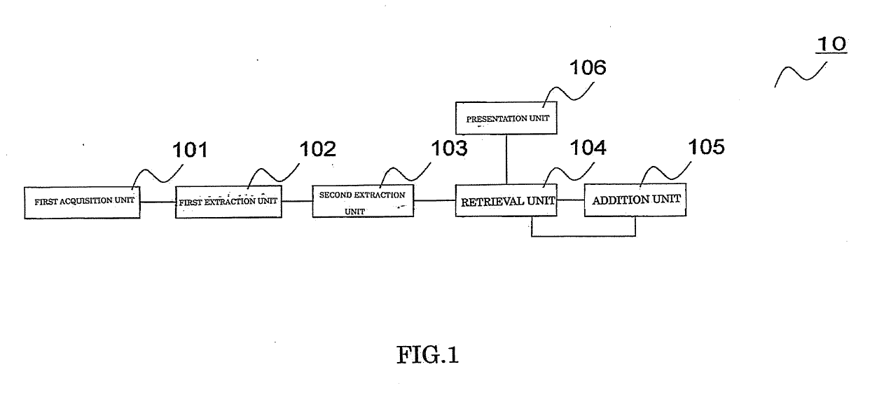

FIG. 1 is a block diagram showing component according to the first embodiment. The person retrieval apparatus of the first embodiment includes a first acquisition unit 101, a first extraction unit 102, a second extraction unit 103, a retrieval unit 104, an addition unit 105, and a presentation unit 106.

The first acquisition unit 101 acquires an image including a plurality of frames. For example, the image is photographed by a fixed imaging device, and acquired at a predetermined interval as a moving image. Here, fixation of position of the imaging device is not always necessary. The image acquired by the first acquisition unit 101 is supplied to the first extraction unit 102.

The first extraction unit 102 extracts a plurality of persons included in the frame acquired. Here, a person including a face-like region may be extracted by face detection technique. Alternatively, by previously training a shape of a target person, the face included in the frame may be extracted by the person-like (similarity between the shape of the target person and a region in question). Next, the first extraction unit 102 extracts an attribute from the person acquired. For example, a shape such as a circle or a square of the face, a color, a shape of an eye, or a color of clothes, are respectively detected from the person included in the frame. Then, a feature and a kind thereof are supplied to the retrieval unit 104.

The second extraction unit 103 extracts a plurality of attributes each specifying a person indicated by a user who utilizes the person retrieval apparatus. Hereinafter, this person is called an indicated person. For example, after the user inputs information of a first person as an image, in the same way as extraction of the feature by the first extraction unit 102, the second extraction unit 103 extracts a feature of the first person from the image. Alternatively, by indicating a kind of the feature of the indicated person by the user, the feature of the indicated person may be generated. For example, by indicating a shape of the face, a color of the skin, a shape of an eye or a nose, or a color of clothes, a feature similar to the attribute of the indicated person may be generated. The second extraction unit 103 supplies the attribute and the kind thereof to the retrieval unit 104.

The retrieval unit 104 selects at least one from attributes (acquired by the second extraction unit 103) as a retrieval condition, and retrieves the indicated person from persons acquired by the first extraction unit 102. Briefly, the retrieval unit 104 decides a person having sufficiently a high similarity for the attribute of the retrieval condition as the same person as the indicated person, and supplies information of this person to the presentation unit 106.

The addition unit 105 compares the attribute acquired by the first extraction unit 102 with the attribute acquired by the second extraction unit 103. Next, the addition unit 105 decides whether at least one attribute not acquired by the second extraction unit 103 but acquired by the first extraction unit 102, or decides whether at least one attribute (acquired by the first extraction unit 102) has a low similarity for the attribute acquired by the second extraction unit 103. For example, even if a person in question is decided as a target person by another attribute, if the person in question wears different clothes from the target person, an attribute of the clothes is added as a new retrieval condition.

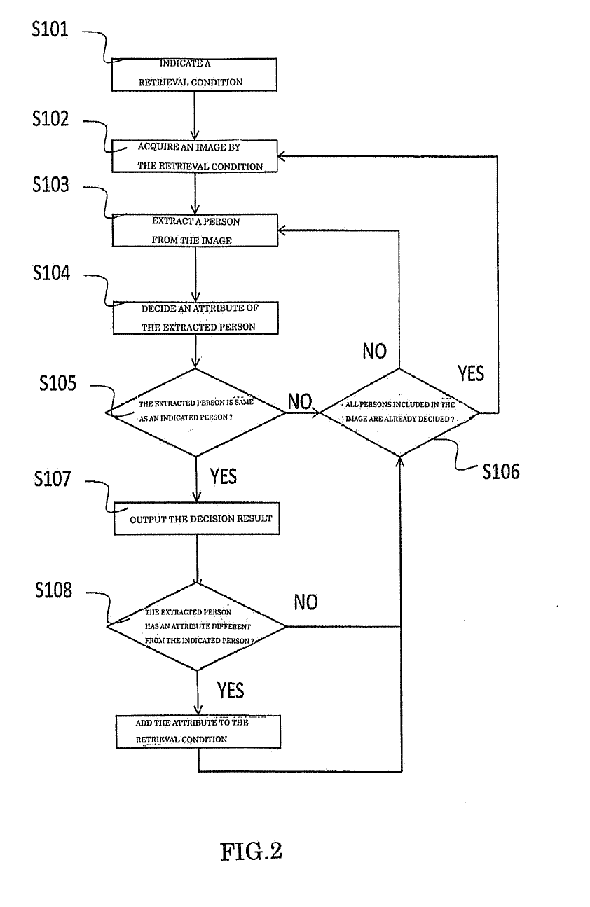

Next, operation of the person retrieving apparatus is explained. FIG. 2 is a flow chart when the person retrieving apparatus performs person-retrieving and addition of the condition.

In the first embodiment, a person (as a retrieval target) is indicated from a frame (image) for retrieving. In the person retrieving apparatus, first, a user indicates a retrieval condition of the indicated person (S101). Specifically, by selecting a person extracted by the second extraction unit 103, the person to be retrieved and an attribute thereof are indicated. By acquiring an image of the indicated person, the attribute may be acquired by the second extraction unit 103. Furthermore, by indicating a person name (or a person ID) and by supplying a video corresponding to the person name to the first extraction unit 102, the attribute acquired by the first extraction unit 102 may be utilized. The person ID and the attribute of each kind corresponding thereto may be acquired from data (database). Furthermore, an attribute not extracted from the indicated image (for example, clothes or a hairstyle) may be indicated.

The first acquisition unit 101 inputs an image (photographed by an imaging device) from the imaging device or a file (S102). This image is a moving image or a plurality of static images.

The first extraction unit 102 extracts a person from the image acquired by the first acquisition unit 101 (S103). In order to extract the person, conventional technique for person-extraction is used. For example, this method is disclosed in [Markus Enzweiler and Dariu M. Gavrila, “Monocular Pedestrian Detection: Survey and Experiments”, IEEE Transactions on Pattern Analysis and Machine Intelligence, Vol. 31, No. 12, pp. 2179˜2195, December 2009]. This extraction is performed for each frame (image). The extraction result may be one person rectangle acquired from one image, or a person locus as a sequence of the person rectangle acquired from a plurality of images.

Next, it is decided whether the person rectangle or the person locus is similar to an attribute of the indicated retrieval condition (S104). As to whether to be similar to the attribute, for example, in case of a face as the attribute, conventional technique for face-recognition is used. For example, the face-recognition method is disclosed in [W. Zhao, R. Chellappa, A. Rosenfeld, and P. J. Phillips, “Face Recognition: A Literature Survey”, ACM Computing Surveys, pp. 399˜458, 2003]. Furthermore, if the indicated retrieval condition is a color name such as clothes, a method for calculating a similarity between a color-space coordinate value of the color name and a cloth region of the person is used. For example, this method is disclosed in [Masaaki Sato, Yuhi Sasaki, Masatake Hayashi, Noriko Tanaka, and Yoshiyuki Matsuyama, “Person Retrieving System Using Clothes Face”, In SSII2005, No. E-44, June 2005]. In this method, by calculating a similarity of color information in the image, the color information having the similarity larger than a predetermined threshold may be extracted as the indicated clothes or color name.

Furthermore, a similarity of a feature such as color histogram or color correrogram of the indicated person region may be used. For example, this method is disclosed in [Kazuhiro Kamimura, Yukihisa Ikegame, Ko Shimoyama, Toru Tamaki, and Masanobu Yamamoto, “A Real Time System for Identifying a Person by Cameras Connected Through a Network”, The Institute of Electronics, Information and Communications Engineers, Technical Report of IEICE, PRMU2003-242, Vol. 103, pp 67˜72, February 2004]. Furthermore, in case of deciding from the biometric attribute changeable such as sex or age, the method is disclosed in [Laurenz Wiskott, Jean-Marc Fellous, Norbert Krddotuger, and Christoph von der Malsburg, “Face Recognition and Gender Determination”, In International Workshop on Automatic Face- and Gesture-Recognition, pp. 92˜97, 1995]. Furthermore, in the same way, as the biometric attribute changeable, a feature such as a hairstyle, a physique, or a gait, can be used. By combining at least two of these attributes, the decision may be performed. Furthermore, as the attribute, various different features disclosed in [Michael Stark and Bernt Schiele, “How Good are Local Features for Classes of Geometric Objects”, 2007] may be used. Furthermore, by detecting a hat or a bag, the attribute such as existence or color thereof may be extracted. Furthermore, not by detecting a specific object (such as a hat or a bag) but by segmenting the object into partial regions (such as a head region, a trunk region, a leg region), a feature (such as a color histogram) may be extracted as the attribute from the partial regions. As a result, the person's attribute can be acquired without detection of the specific object (such as a hat or a bag).

The retrieval unit 104 calculates a decision score from a plurality of attributes. The decision score is calculated based on weighted sum of similarity of the plurality of attributes extracted by the first extraction unit 102 and the second extraction unit 103. When the decision score is larger than a predetermined threshold, the extracted person is decided as the indicated person (S105). If the extracted person is not the indicated person, another person included in the image is decided. When decision of all persons included in the image is completed, a next image is processed (S106). If the extracted person is the indicated person, this retrieval result is outputted (S107), and outputted via the presentation unit 106.

The addition unit 105 checks whether an attribute of the person decided as the indicated person is different from the attribute included in the retrieval condition (S108). When a similarity of the attribute of the person is smaller than a predetermined threshold, this attribute is decided as a sufficiently different attribute from the retrieval condition. In this case, the addition unit 106 adds this different attribute to the retrieval condition (S109).

More specifically, the case that the indicated person changes clothes thereof is explained. When the indicated person has changed his/her clothes, even if a person in question is decided as the indicated person by another attribute such as a face or a hairstyle, the attribute of clothes is largely different from the indicated person. Accordingly, as a new attribute, clothes after changing is added to the retrieval condition. Furthermore, when the indicated person has changed his/her hairstyle or decorations (belongings) such as a hat or a bag, in the same way, a new attribute such as head texture information of the person or the belongings is added to the retrieval condition.

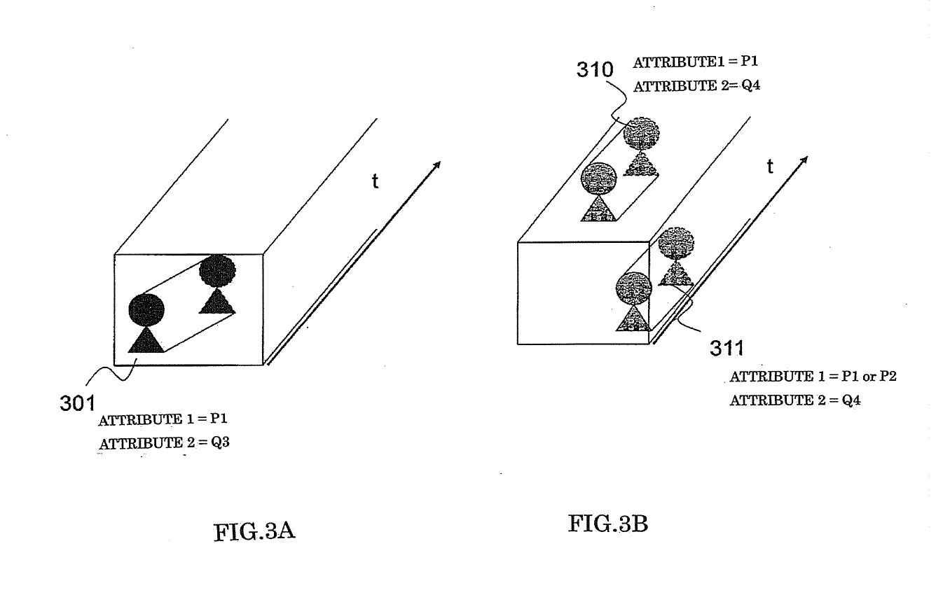

FIGS. 3A and 3B are schematic diagrams to explain addition of attributes. In FIG. 3A, as to indicated person data 301, an attribute 1 is P1 and an attribute 2 is Q3. In FIG. 3B, an attribute 1 of person data 310 is P1, an attribute 2 of person data 310 is Q4, an attribute 1 of person data 311 is P1 or P2, and an attribute 2 of person data 311 is Q4. Here, the attribute 2 of person data 310 is different from the attribute 2 of indicated person data 301. On the other hand, the attribute 1 of person data 310 is same as the attribute 1 of indicated person data 301. Accordingly, an extracted person 310 is decided to be same as the indicated person 301. In this case, it is decided that the attribute 2 of indicated person data 301 has not only Q3 but also Q4. Accordingly, the addition unit 105 adds not only “the attribute 2=Q3” but also “the attribute 2=Q4” to the retrieval condition. By addition of the retrieval condition, another extracted person 311 having “the attribute 2=Q4” is also decoded to be same as the indicated person 301. If the retrieval condition is not added, “the attribute 2=Q4” of person data 311 is different from “the attribute 2=Q3” of indicated person data 301, and the extracted person 311 is erroneously decided to be not same as the indicated person 301. However, in the first embodiment, this erroneous decision can be suppressed.

In retrieval method of conventional technique, person's attribute/feature is affected by change of environment such as change of illumination. However, as the assumption, the person's attribute/feature is not basically changed. Accordingly, for example, when a person wearing suits takes off a coat, i.e., when an attribute (including a feature) of the person is largely changed, this person is not correctly decided as the same person. As a result, omission of search results (false negative error) occurs. On the other hand, in the first embodiment, even if the attribute/feature such as clothes is changed, the case of deciding as the same person by another attribute/feature is supposed, and this changed attribute is newly added to the retrieval condition. In following processing, this changed attribute is added to a condition to decide as the same person. As a result, omission of search results is hard to occur. Especially, this technique is effective for multimodal recognition to decide based on many attributes.

Moreover, addition processing of these conditions is not necessarily performed in order of time series. Briefly, whenever a new image is processed, the condition is not necessarily to be gradually added. For example, all retrieval conditions to be added may be determined by processing all image data once, and the all image data may be processed again based on the all retrieval conditions added. In processing for a video stored, processing based on all conditions can be performed, and omission of search results can be further suppressed. Furthermore, respective retrieval conditions are not necessarily contributed to decision with same importance degree. For example, when a new retrieval condition is added at S109 of FIG. 2, by a value of score decided as the indicated person, a weight of the new retrieval condition used for decision may be changed.

(Modification 1)

By the addition unit 105, a user may indicate a method for adding the condition at S109. As the method, for example, the condition is automatically added, the condition is added after confirming addition thereof by inquiring the user respectively, or the condition of a specific attribute is permitted to be automatically added. Furthermore, when a score (similarity) decided as the indicated person at S108 is larger than some value, addition of the condition may be permitted. Alternatively, when a differential degree (low of similarity) of attribute/feature at S108 is within some range, addition of the condition may be permitted. By indicating an additional condition by the user, an extension of a retrieval condition for the user not to intend can be suppressed.

(Modification 2)

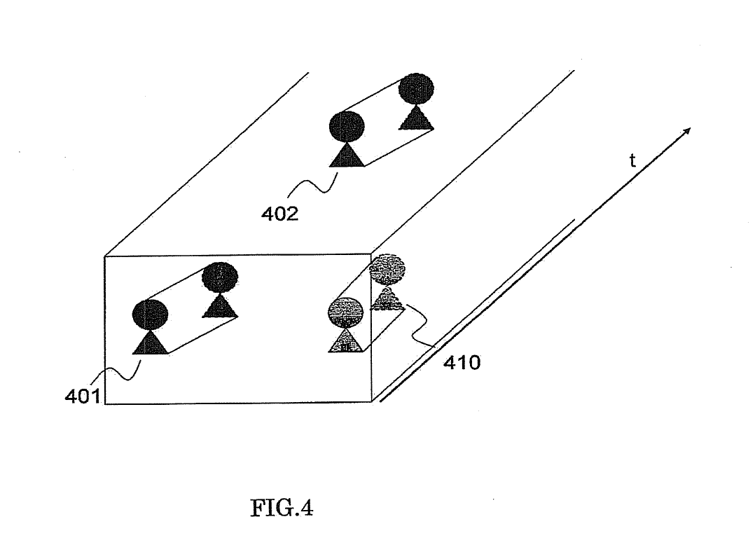

Person data having a high possibility not to be the indicated person may be excluded from retrieval targets. FIG. 4 shows the case that a plurality of persons is detected from a video. The retrieval unit 104 decides whether a detected person is the indicated person. If the detected person is the indicated person (Yes at S105), following processing is performed. Assume that person data 401 decided to be same as the indicated person exist (S105). In this case, another person data 410 simultaneously existing with the person data 401 in the image is decided to be not the indicated person. Accordingly, when the retrieval unit 104 decides the indicated person, another person (For example, 410) included in a frame (image) simultaneously including the indicated person may be excluded from retrieval targets. By limiting person data to be decided, unnecessary decision processing is omitted, and the processing can be quickly performed.

Furthermore, person data 402 not simultaneously existing with the indicated person 401 in the image has a possibility to be the indicated person. Accordingly, the person data 402 had better not be excluded from retrieval targets. Furthermore, in FIG. 4, if two persons 401 and 410 are extremely adjacent, the same person in the image may be doubly extracted. In this case, by estimating a distance between two persons 401 and 410 in the image, if the distance is smaller than a predetermined threshold, above-mentioned exclusion processing had better not be performed.

(Modification 3)

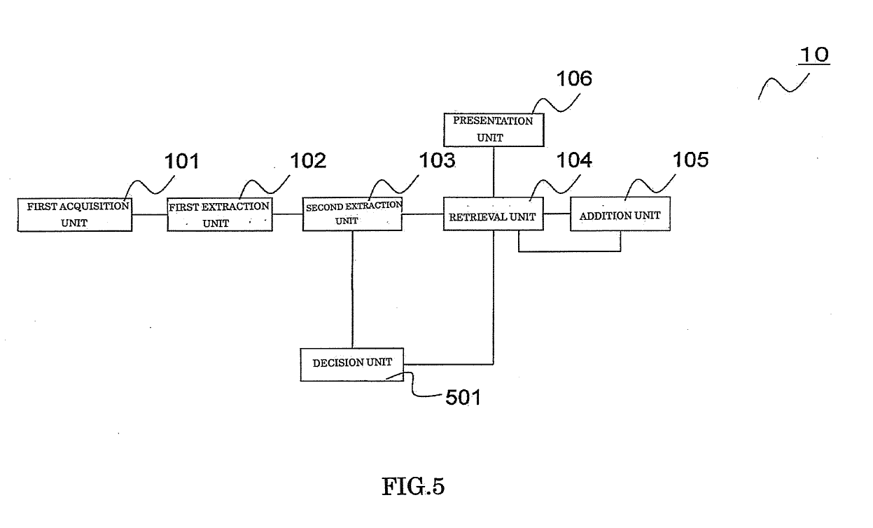

FIG. 5 is a block diagram of the person retrieving apparatus further including a decision unit 501 to determine the indicated person. The decision unit 501 calculates a similarity between an attribute acquired by the first extraction unit 102 and an attribute acquired by the second extraction unit 103, and decides whether a retrieved person is the indicated person. This feature is different from the first embodiment. More specifically, a decision score is weighted.

As to a person simultaneously detected from a frame including the indicated person, a possibility that this person is not the indicated person is high. The decision unit 501 lowers a weight of a detection target having a high possibility not to be the indicated person. As a result, as to person data having a high possibility not to be the indicated person, a low score is assigned.

For example, as explained in modification 2, even if a person is simultaneously detected from the frame including the indicated person, the case that this person had better not be excluded from retrieval targets exists. Accordingly, as to a decision score to which a plurality of attributes is weighted, a condition representing whether this person is simultaneously detected from the image including the indicated person is set. Briefly, as to the decision score of the person simultaneously detected from the image including the indicated person, this decision score is weighted to be lowered, and the retrieval unit 104 retrieves the indicated person by using the decision score weighted.

In the same way as modification 2, as to person data not simultaneously detected from the image including the indicated person, a person of the person data may be same as the indicated person. Accordingly, a decision score of this person had better not be weighted. Alternatively, the decision score may be weighted to be heightened.

### The Second Embodiment

Next, the person retrieving apparatus of the second embodiment is explained. Moreover, as to same unit as the first embodiment, same sign is assigned, and its explanation is omitted.

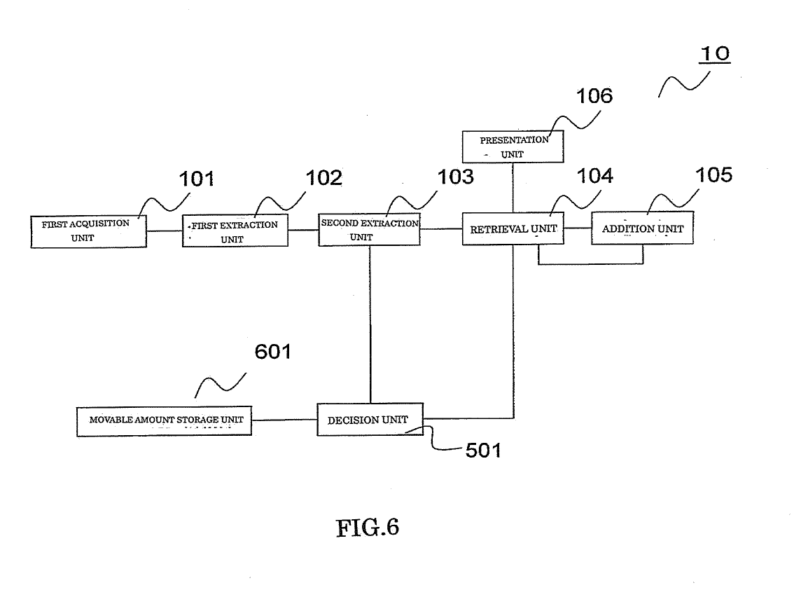

FIG. 6 is a block diagram of the person retrieving apparatus according to the second embodiment. In the second embodiment, a movable amount storage unit 601 to store a movable amount of a person (extracted by the first extraction unit 102) is further equipped.

The decision unit 501 acquires a movable amount of the person from the movable amount storage unit 601. When a distance between an imaging position of a person decided as the indicated person and an imaging position of another person (detected by the first extraction unit 102) is larger than the movable amount, the decision unit 501 lowers a similarity between the indicated person and the another person. As a result, a decision score of the another person is lowered.

More specific processing of the person retrieving apparatus is explained. As an example, person data decided as the indicated person (S105) and another person data (extracted by the first extraction unit 102) having a different imaging position are processed. Specifically, first, processing of S101-S105 are performed in the same way as the first embodiment. The movable amount storage unit 601 stores an estimated movable distance of a person as a movable amount. The decision unit 501 estimates a movable distance of the indicated person by the indicated person data and the movable amount (acquired from the movable amount storage unit 601). When a distance between an imaging position of the indicated person and an imaging position of a person extracted by the first extraction unit 102 is larger than the movable distance, the decision unit 501 lowers a similarity to lower a decision score of the extracted person.

The movable amount storage unit 601 stores various movable distances of persons as the movable amount. When above-mentioned distance is larger than a movable distance estimated by using the movable amount storage unit 601, the indicated person and the extracted person cannot be connected, and the extracted person is decided not to be the indicated person.

For example, when person data of an extracted person is located at a position over a movable range of the indicated person (decided by the retrieval unit 104) in the image, a weight of a decision score of the extracted person is lowered, or the extracted person is excluded. If the extracted person is excluded from retrieval targets, person data to be decided by the retrieval unit 104 is limited. The retrieval unit 104 can omit unnecessary decision processing, and entire processing can be quickly performed. Furthermore, if a low decision score is assigned to person data having a high possibility not to be the indicated person, a possibility that retrieval result of erroneous person is outputted can be suppressed.

In above-mentioned explanation, the movable amount storage unit 601 calculates a movable distance. However, any means for estimating a person's movable distance may be used.

(Modification 1)

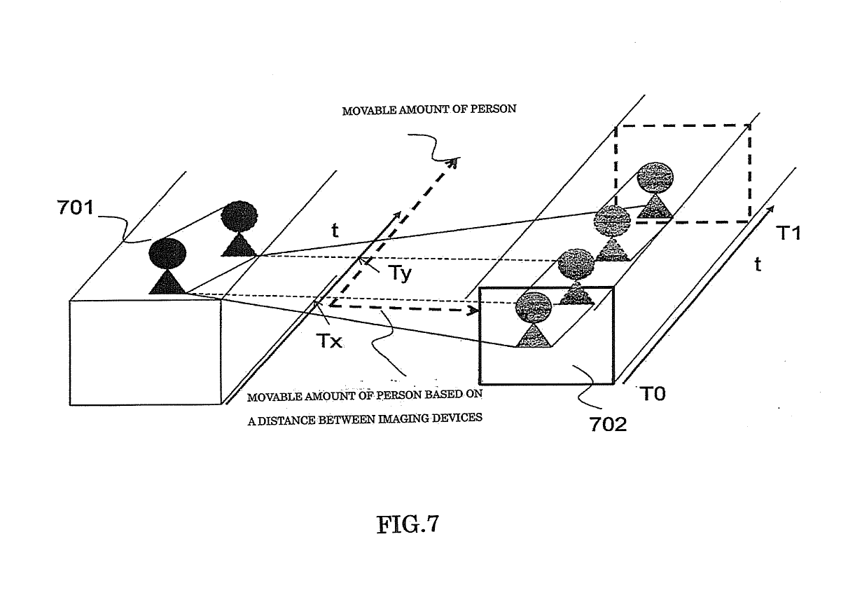

The case that an imaging time of an imaging device is mutually corresponded among a plurality of imaging devices is explained. First, in the same way as the second embodiment, processing of S101˜S105 is performed. For example, when the indicated person is detected from a video acquired by a first imaging device, an imaging time of the first imaging device is corresponded to an imaging time of a second imaging device. A movable distance between the first imaging device and the second imaging device is acquired from the movable amount storage unit 601, and a time segment (For example, T0˜T1 in FIG. 7) at which the indicated person cannot move in an imaging time of the second imaging device is estimated. If this time segment is overlapped with a time segment T0˜T1 of images acquired by the second imaging device, a decision scored of a person detected from the time segment T0˜T1 of images is lowered.

For example, in FIG. 7, the left side shows a video acquired by the first imaging device, and the right side shows a video acquired by the second imaging device. This video may be acquired for each frame. In FIG. 7, the images are aligned in order of time sequence. Briefly, the images are continuously displayed along a time direction (t) from this side to a depth direction.

In order for the first imaging device to image a person 701, based on the person's movable amount between two imaging devices, the person 701 must be remotely located from a view of the second imaging device before a time T0. In the same way, after the person 701 is imaged by the first imaging device, based on the person's movable amount between two imaging devices, the person 2 can be imaged by the second imaging device after a time T1. Accordingly, the second imaging device cannot image the person 701 in a time segment between T0 and T1.

In the same way, when the person 701 is detected in a time segment between Tx and Ty by the first imaging device, a person 702 detected in a time segment between T0 and T1 (including the time segment between Tx and Ty) by the second imaging device is not same as the person 701. In this case, a decision score of the person 702 may be lowly weighted, or the person 702 may be excluded from retrieval targets. If the person 702 is excluded from retrieval targets, person data to be decided by the retrieval unit 104 is limited. As a result, the retrieval unit 104 can omit unnecessary decision processing, and entire processing can be quickly performed. Furthermore, if a low decision score is assigned to person data having a high possibility not to be the indicated person, a possibility that retrieval result of erroneous person is outputted can be suppressed.

### The Third Embodiment

Next, training data connection apparatus (attribute collection apparatus) of the third embodiment is explained. As to same unit as the first embodiment, same sign is assigned, and its explanation is omitted.

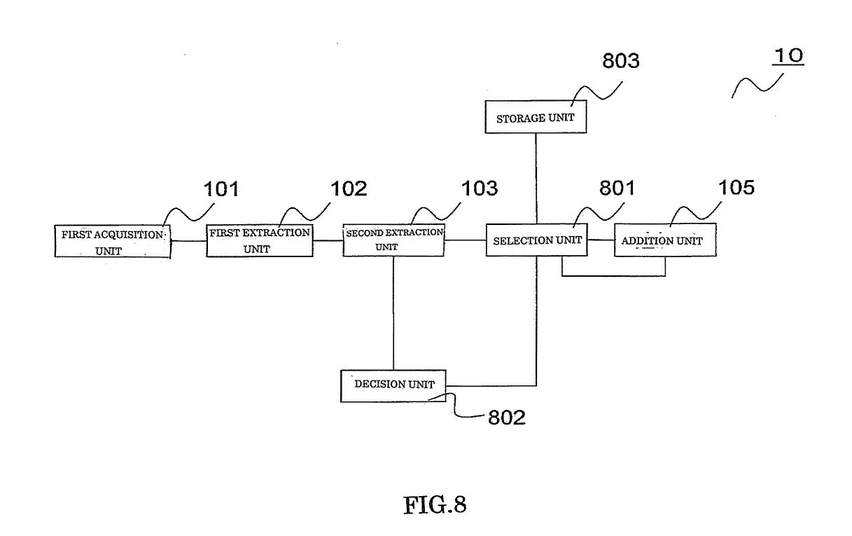

FIG. 8 is a block diagram showing component of the attribute collection apparatus according to the third embodiment. The attribute collection apparatus includes the first acquisition unit 101, the first extraction unit 102, the second extraction unit 103, a selection unit 801, a decision unit 802, the addition unit 105, and a storage unit 803. Here, the selection unit 801 to select at least one of first attributes (extracted by the first extraction unit 102) as the retrieval condition is included. Furthermore, the storage unit 803 to store new attributes selected by the selection unit 801 or added by the addition unit 105 is included. These two units are different from the first embodiment.

In the attribute collection apparatus of the third embodiment, the first acquisition unit 101 acquires an image, and the first extraction unit 102 extracts a person from the image. In order to extract the person, the same method as the first embodiment is used. The second extraction unit 103 extracts attributes of an indicated person (indicated by a user), and the selection unit 801 selects one of the attributes. The decision unit 802 detects candidates of the indicated person based on the selected attribute from the image. If at least one attribute of the candidates is different from the attributes of the indicated person, the selection unit 801 newly adds the at least one attribute to the storage unit 803.

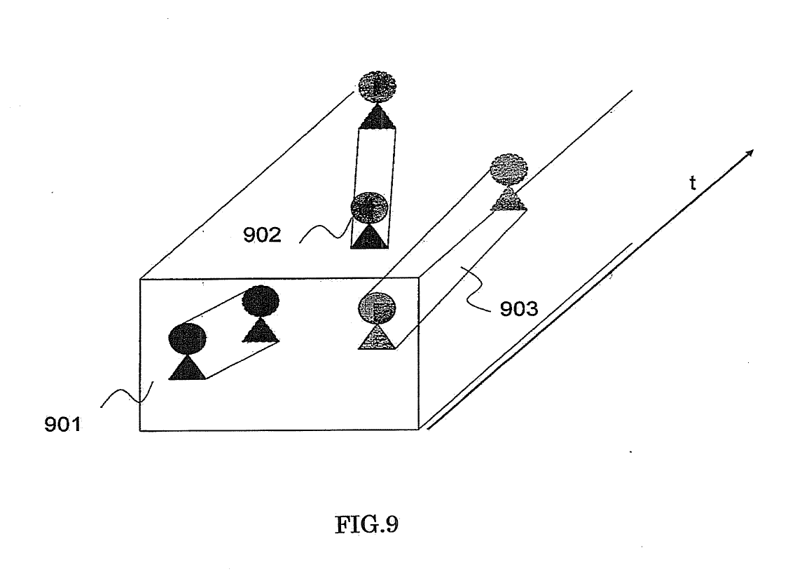

Next, processing to add a new attribute into the storage unit 803 is explained. FIG. 9 is an example that a plurality of persons is extracted from a video according to the third embodiment.

TABLE 1

| | Seq1 | Seq2 | Seq3 |
|---|---|---|---|
| Seq1 | (1.0) | 0.5 | 0.5 |
| Seq2 | — | (1.0) | 0.5 |
| Seq3 | — | — | (1.0) |

A table 1 shows the case that three persons (901, 902, 903) is extracted from the video. A locus of a person 901 is seq1, a locus of a person 902 is seq2, and a locus of a person 903 is seq3. In this case, the person retrieving apparatus or the selection unit 801 stores information representing whether respective persons are the same person based on a similarity (coincidence degree), i.e., the table 1. Here, a coincidence degree “1.0” represents a pair of the same person, a coincidence degree “0.0” represents a pair of others, and a coincidence degree “0.5” represents the pair of the same person or the pair of others. In FIG. 9, the person 901 (seq1) and the person 903 (seq3) simultaneously exist in the same image. Accordingly, the decision unit 802 decides that the person 901 and the person 903 are the pair of others, and sets a coincidence degree between seq1 and seq3 to “0.0” (others). In this case, the table 1 is updated to the table 2.

TABLE 2

| | Seq1 | Seq2 | Seq3 |
|---|---|---|---|
| Seq1 | (1.0) | 0.5 | 0.0 |
| Seq2 | — | (1.0) | 0.0 |
| Seq3 | — | — | (1.0) |

In the same way, in FIG. 9, the person 902 (seq2) and the person 903 (seq3) simultaneously exist in the same image. Accordingly, the decision unit 802 decides that the person 902 and the person 903 are the pair of others, and sets a coincidence degree between seq2 and seq3 to “0.0” (others).

In this way, as to a person's rectangle/locus simultaneously existing in the image, processing to decide whether rectangles/loci are others can be repeatedly performed. The attribute collection apparatus can determine many data of target persons and others without a user's teaching operation. More specifically, from information of the table 2, seq3 having the coincidence degree “0.0” is used as others data of seq1 (Conversely, seq1 is used as others data of seq3). Furthermore, as others data of seq2, seq3 having the coincidence degree “0.0” is used (Conversely, seq2 is used as others data of seq3). These data to identify the target person and others can be used as training data of a discriminator to decide whether a pair (Pa, Pb) of specific person data is the pair of the same person or the pair of others. The training data is stored into the storage unit 803.

For example, assume that an attribute (including a feature) acquired from Pa is Fa, an attribute (including a feature) acquired from Pb is Fb, and a differential feature of a pair thereof is Fab (=Fa−Fb). In this case, SVM (Support Vector Machine) discriminator can be trained so as to discriminate many Fab acquired from the pair of the same person and many Fab acquired from the pair of others.

As a result, based on a differential feature Fcd acquired from a pair (Pc, Pd) of some input data, SVM discriminator to decide whether this pair is the pair of the same person or the pair of others can be acquired. For example, this SVM discriminator is used as the retrieval unit 104 of the first embodiment.

Furthermore, assume that the decision unit 802 stores data of following table 3.

TABLE 3

| | Seq1 | Seq2 | Seq3 |
|---|---|---|---|
| Seq1 | (1.0) | 0.5 | 0.5 |
| Seq2 | — | (1.0) | 0.0 |
| Seq3 | — | — | (1.0) |

By the same processing as the retrieval unit 104 of the first embodiment, seq1 and seq2 are decided as the same person. In this case, by setting the coincidence degree between seq1 and seq2 to “1.0” (the same person), the table 3 is updated to a table 4.

TABLE 4

| | Seq1 | Seq2 | Seq3 |
|---|---|---|---|
| Seq1 | (1.0) | 1.0 | 0.0 |
| Seq2 | — | (1.0) | 0.0 |
| Seq3 | — | — | (1.0) |

In this case, seq1 and seq2 are the same person, and seq2 and seq3 are different persons. Accordingly, seq1 and seq3 are different persons, and the coincidence degree between seq1 and seq3 is updated to “0.0” (others). In this way, by processing to decide whether to be the same person, many data of the same person and others can be determined.

Moreover, in above explanation, seq1 and seq2 are certainly decided as the same person (coincidence degree “1.0”). However, if they are not certainly decided, for example, the coincidence degree between seq1 and seq2 may be “0.8” (probably the same person). Here, seq2 and seq3 are others (coincidence degree “0.0”). Accordingly, seq1 and seq3 are not decided to be certainly others, but they can be decided to be probably others (coincidence degree “0.2”). In this case, as a pair of others data, by setting a predetermined threshold, the pair sufficiently decided to be others (For example, coincidence degree is smaller than “0.2”) can be used. Furthermore, as a pair of the same person data, by similarly setting a predetermined threshold, the pair sufficiently decided to be the same person (For example, coincidence degree is larger than “0.8”) can be used.

(Modification 2)

The attribute collection apparatus may include the same person/others data input unit, and a user may partially input decision information of the same person/others data thereby. Furthermore, in the same way as the second embodiment, by suitably combining the case that two images of which imaging positions are apart or the case that an estimated distance between two imaging positions is longer than a movable distance, learning data thereof can be used as others data.

According to above-mentioned embodiments, from a monitoring camera video or a television video, the indicated person can be retrieved. Furthermore, training data to identify a person necessary for the retrieval apparatus can be collected.

In the disclosed embodiments, the processing can be performed by a computer program stored in a computer-readable medium.

In the embodiments, the computer readable medium may be, for example, a magnetic disk, a flexible disk, a hard disk, an optical disk (e.g., CD-ROM, CD-R, DVD), an optical magnetic disk (e.g., MD). However, any computer readable medium, which is configured to store a computer program for causing a computer to perform the processing described above, may be used.

Furthermore, based on an indication of the program installed from the memory device to the computer, OS (operating system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

While certain embodiments have been described, these embodiments have been presented by way of examples only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An apparatus for retrieving information about an indicated person from an image, comprising:
a first acquisition unit configured to acquire the image including a plurality of frames;
a first extraction unit configured to extract a plurality of persons from the frames, and to extract a plurality of first attributes from each of the persons, the first attributes featuring each person;
a second extraction unit configured to extract a plurality of second attributes from a first person indicated by a user, the second attributes featuring the first person;
a retrieval unit configured to retrieve information about a person similar to the first person from the persons, based on at least one of the second attributes as a retrieval condition; and
an addition unit configured to, when at least one of the first attributes of a retrieved person by the retrieval unit is different from the second attributes, add the at least one of the first attributes to the retrieval condition.

2. The apparatus according to claim 1, wherein
the first attributes and the second attributes respectively include at least one of a first feature biometrically peculiar to each person and a second feature representing a temporary appearance of each person.

3. The apparatus according to claim 2, wherein
the retrieval unit sets the first feature and the second feature to the retrieval condition.

4. The apparatus according to claim 2, wherein
the retrieval unit retrieves the person similar to the first person, based on the first attributes acquired from a plurality of partial regions of the frames.

5. The apparatus according to claim 1, further comprising:
a presentation unit configured to, when the addition unit adds the at least one of the first attributes to the retrieval condition, present the at least one of the first attributes to the user.

6. The apparatus according to claim 1, further comprising:
a decision unit configured to decide whether the retrieved person is the first person, based on a similarity between the first attributes of the retrieved person and the second attributes.

7. The apparatus according to claim 6, wherein
the decision unit decides that the retrieved person is the first person, when the similarity is larger than a predetermined threshold, and lowers other similarities between the first person and the other persons included in the frames including the retrieved person.

8. The apparatus according to claim 6, further comprising:
a storage unit to store a movable amount of the persons;
wherein
the first acquisition unit acquires a first image and a second image having respective imaging times and respective imaging positions, and
the decision unit acquires the movable amount, and lowers the similarity of the retrieved person, when a distance between the respective imaging positions is larger than a distance calculated by the movable amount and a time difference between the respective imaging times.

9. An apparatus for collecting attributes, comprising:
a first acquisition unit configured to acquire an image including a plurality of frames;
a first extraction unit configured to extract a plurality of persons from the frames, and to extract a plurality of first attributes from each of the persons, the first attributes featuring each person;
a second extraction unit configured to extract a plurality of second attributes from a first person indicated by a user, the second attributes featuring the first person;
a selection unit configured to select at least one of the second attributes as a retrieval condition;
a decision unit configured to retrieve a candidate decided as the first person from the persons, based on a similarity between the first attributes and the at least one of the second attributes; and
an addition unit configured to, when at least one of the first attributes of the candidate is different from the second attributes, add the at least one of the first attributes to the second attributes.

10. The apparatus according to claim 9, further comprising:
a storage unit to store a movable amount of the persons;
wherein
the first acquisition unit acquires a first image and a second image having respective imaging times and respective imaging positions, and
the decision unit acquires the movable amount, and lowers the similarity of the candidate, when a distance between the respective imaging positions is larger than a distance calculated by the movable amount and a time difference between the respective imaging times.
